(19) United States
(12) Patent Application Publication
(10) Pub. No.: US 2010/0228667 A1
(43) Pub. Date: Sep. 9, 2010

(54) SYSTEM AND METHOD FOR ON-STREET PARKING REVENUE MODEL FOR ELECTRONICALLY COLLECTING FEES

(76) Inventors: Rajesh M. Kalwani, Miami, FL (US); Arturo H. Garcia, Miami, FL (US)

Correspondence Address: STEVENS & SHOWALTER LLP, 7019 CORPORATE WAY, DAYTON, OH, 45459-4238, US

(21) Appl. No.: 12/716,321

(22) Filed: Mar. 3, 2010

Related U.S. Application Data
(60) Provisional application No. 61/157,926, filed on Mar. 6, 2009.

(51) Int. Cl. G06F 17/00; G06Q 40/00; G06K 19/06

(52) U.S. Cl. 705/39; 705/418; 235/375

(57) ABSTRACT

A system and method for collecting on-street parking revenue. The method utilizes a device which establishes a link with a server. Once the device is validated and the location of the vehicle is established, a message is transmitted to the device with the parking rates for that location. The time that the vehicle is parked at the location is tracked. The parking charges are collected electronically by charging the user's account based upon the parking rates and the time that the vehicle was parked at that location.

This application claims the benefit of U.S. Provisional Application No. 61/157,926, filed Mar. 6, 2009 and entitled “SYSTEM AND METHOD FOR ON-STREET PARKING REVENUE MODEL FOR ELECTRONICALLY COLLECTING FEES,” the disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

This invention pertains to a method and apparatus for collecting parking revenue. More specifically, the invention pertains to a method and apparatus for electronically collecting and transferring pre-mapped on-street and/or off-street parking revenue in real time.

### SUMMARY OF THE INVENTION

In accordance with a first aspect of the present invention, a method is provided for collecting parking revenue comprising the steps of: validating a device associated with a user account, wherein the device is validated as being genuine and located at a parking location; transmitting a message to the device, wherein the message includes at least one of: the parking location of the device, a parking rate for the parking location, and a balance of the user account; tracking a parking time that the device is located at the parking location; and calculating parking revenue, wherein the parking revenue is based upon the parking rate and the parking time.

The method may further comprise sending an error message to the device, wherein the error message may include a message comprising one of: insufficient funds, non-subscribing location, free parking zone and free parking time.

The method may further comprise adding user funds to a user account.

The method may further comprise transferring funds to a bank account. Transferring of funds to a bank account may comprise transmitting a first percentage of a transaction to a municipality bank account and transmitting a second percentage of the transaction to a service provider account, wherein the second percentage is a transaction fee.

The method may further comprise verifying collection of parking revenue. Verification of the collection of the parking revenue may comprise: receiving scanned bar code information taken from a bar code on the device by an enforcement personnel; confirming the validation of the device; and transmitting collection information, wherein the collection information communicates to the enforcement personnel that the parking revenue is being collected.

The method may further comprise collecting parking revenue from a user account.

The method may further comprise providing to a user a parking activity report, wherein the parking activity report includes: a usage record of the device and a transactional history record of the user account.

In accordance with a second aspect of the present invention, a system is provided for collecting parking revenue comprising: a server comprising: a receiver configured to receive a message from a device at a parking location; a validator configured to validate the device as being genuine and located at a parking location; a timer configured to track a parking time; and a calculator configured to calculate a parking revenue based upon a parking rate for the parking location and the parking time.

The server may further comprise an account manager configured to define a user account associated with the device and a revenue collector configured to collect parking revenue from the user account.

The server may further comprise a collection manager configured to verify collection of the parking revenue.

Verification of the collection of the parking revenue by the server collection manager may comprises: receiving scanned bar code information taken from a bar code on the device by an enforcement personnel; confirming the validation of the device; and confirming funds are in a user account such that parking revenue may be collected.

In accordance with a third aspect of the present invention, a self-locating device is provided for transmitting parking related information comprising: a first receiver configured to acquire a position of the device via GPS; a transmitter configured to transmit the location of the device to a server; a second receiver configured to receive information back from the server comprising current parking rates; and a display for displaying the information.

The self-locating device may comprise a transponder or a cell phone.

The self-locating device may further comprise a bar code so as to allow an enforcement personnel to verify the collection of parking revenue.

The self-locating device may further comprise a deactivation circuit to deactivate the device and the transmitter being further configured to generate a corresponding signal to a server indicating that parking has ended.

### BRIEF DESCRIPTION OF THE DRAWINGS

FIG. 1 is a flowchart of an exemplary embodiment of the process in accordance with the present invention;

FIG. 1(a) is a schematic illustration of a server used in the present invention;

FIGS. 2(a)-(c) are illustrations of the front, side, and back view of the device that may be linked to a server in accordance to the present invention;

FIG. 2(d) is a schematic illustration of the device illustrated in FIGS. 2(a)-(c);

FIGS. 3(a)-(c) show error messages in accordance to the present invention;

FIG. 4 shows an embodiment of a system in accordance to the present invention; and,

FIG. 5 shows an embodiment of a system in accordance to the present invention, wherein an enforcement personnel may verify the collection of parking revenue.

### DETAILED DESCRIPTION OF THE INVENTION AND THE PREFERRED EMBODIMENTS

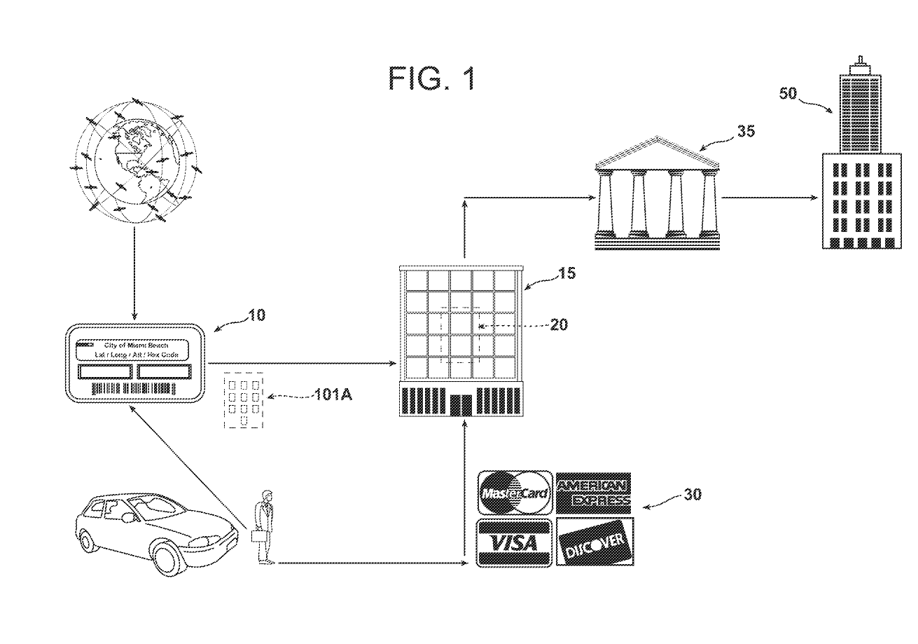

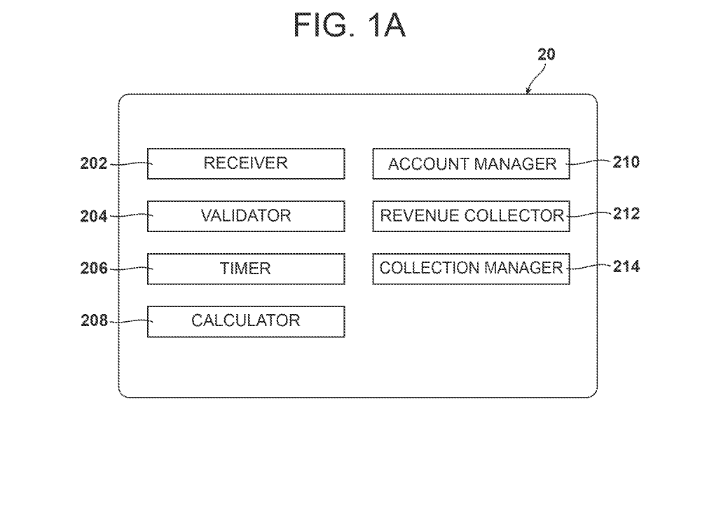

The present invention provides a novel, cost effective, and seamless way for cities and municipalities to collect pre-mapped on-street and/or off-street parking revenue with minimal collection cost. Embodiments may use software with Global Positioning System (GPS), terrestrial, and/or wireless technology to establish a link between a user device 10, a transponder in a first embodiment, and a server 20 of a service provider 15, see FIG. 1. Data may be transmitted in one direction through the use of GPS technology while data that is transmitted in the other direction may use wireless technology.

FIG. 1 represents a flowchart of an exemplary embodiment of the process in accordance with the present invention.

Upon activation, the device 10 may self-locate itself using GPS technology. Activation of the device 10 will be discussed below. The device 10 may then communicate its location by sending a short message service (SMS) to the server 20. Preferably, the server 20 has pre-mapped information regarding all on-street and off-street parking locations within each city subscribing to the service. The SMS may be sent by using a built-in GPRS chip. The encrypted SMS message gives the device location and the time that the device was activated. Upon receiving an SMS message from a device 10, the server 20 may validate the account information and send confirmation back to the device 10 via a SMS message in order to confirm that funds are available and that the device location is within a city that subscribes to the service provider 15. Although GPRS communications technology is provided as an example method for exchanging messages, embodiments of the present invention also contemplate using any of a wide variety of available alternative wireless communications technologies as well for exchanging messages between the server 20 and the device 10.

The device 10 can be deactivated manually by the user or automatically by the device software when the device 10 is moved a certain distance from its location, such as 100 meters. Upon the device 10 being deactivated or 5 minutes after being moved from the original location, a second SMS message is sent to the server 20 in order to provide the time of deactivation. The time between the two SMS messages is the period of time for which the device account will be charged based on the city's on-street or off-street parking rates.

Upon receiving the transponder defining the device 10, the user may set up an account either on-line or by phone. The account may be linked to a credit card 30, see FIG. 1. An initial amount may be transferred from the user's credit card 30 to the user account maintained by the service provider 15. The user may also authorize the service provider 15 to make transfers from its credit card 30 to the user or device account when the funds in his/her account reach a certain amount. In addition to the pre-mapped on-street and/or off-street parking rates, the user may also be charged a monthly service and maintenance fee.

All account information may be kept on servers 20 at the service provider 15. The amount of usage per account per city and the amount of money due to the city 50 for every 24 hours is calculated. Servers may send pertinent information to the financial institution 35 that holds the money and request the transfer of the appropriate amounts of money due to the city 50 for every 24 hour period.

The city 50 may receive the amounts of money due to the city 50 based on the program that the city 50 has subscribed. Such programs may include pre-paid programs whereby the service provider 15 will purchase on-street parking time from the city 50 in bulk at a discounted rate.

Embodiments may be established without any up-front costs or set-up costs to be borne by the city 50 or municipality. Once the city 50 becomes an active subscriber of a service embodying the present invention, parking revenue may be electronically collected and transferred to the city account in real time. The system may be internet based. In addition, the user can be set up and be ready to use the system within minutes of receiving the device 10.

The device 10 can be ordered directly from a service provider's website. The device 10 can also be purchased from a national retailer or convenience store. Also, the device 10 may arrive in a single unit retail pack. The box may include the device 10, instruction manual, and a USB cable/car charger.

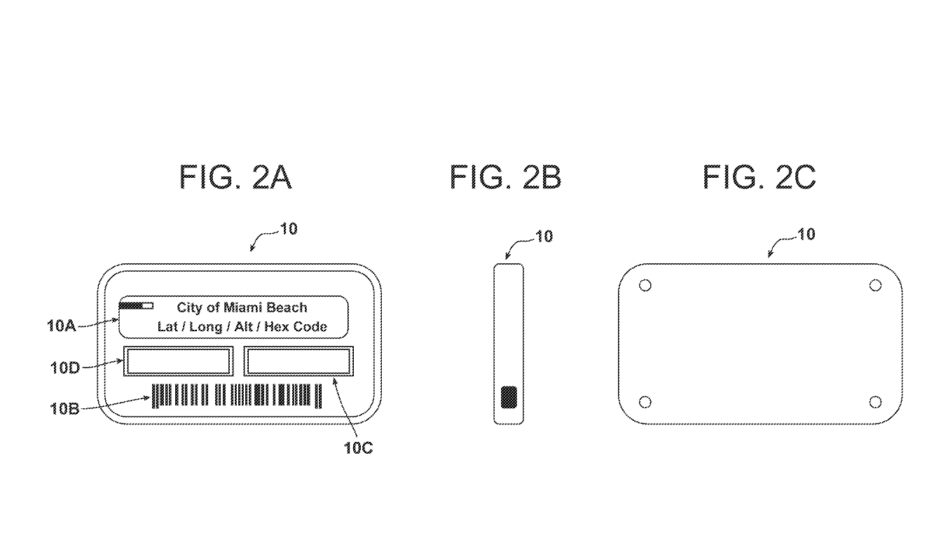

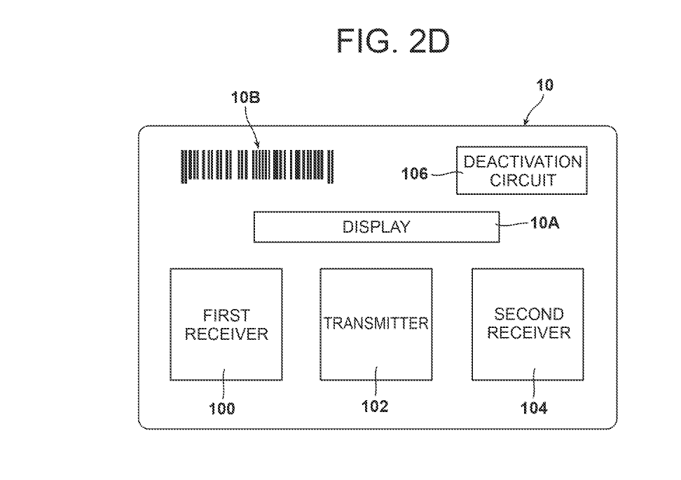

The device 10 may comprise a first receiver 100 comprising conventional GPS hardware/software to acquire a position of the device, a transmitter 102 configured to transmit the location of the device to the server 20, a second receiver 104 configured to receive information back from the server 20 comprising current parking rates, and a display panel 10A. The transmitter 102 and the second receiver 104 may comprise a GPRS transceiver, for example. The display panel 10A, such as an LCD display, communicates information to the user, see FIG. 2a. The device 10 further comprises a deactivation circuit 106 to deactivate the device 10. The transmitter 102 is further configured to generate a corresponding signal to the server 20 indicating that parking has ended. Additionally, the device 10 may have a bar code 10B which may be scanned by enforcement personnel in order to verify the collection of revenue, see FIG. 2a. An exemplary depiction of the device 10 is shown in FIG. 2(a)-(d). Although GPS is discussed as a technique for determining the position of the device, it is only one example of a location-determining service and embodiments of the present invention contemplate operating with alternative location-determining services whether presently deployed or developed in the future.

Upon receiving the device 10, the user may either call in or log on to a service provider's website. The user may create an account for the particular device 10 by entering personal information and a credit card for billing. The user can add funds to the user or device account on a one time basis or set up their account so that funds are transferred from their credit card to their device account once the device balance is at a threshold that has been predetermined by the user. Once the device account is activated, the device 10 is ready to be used by the user.

From the user's perspective, there are many benefits that result from the present invention, such as: no coins, no cards, no meters, no pay and display machines, and no calls to make. A user may arrive at the on-street or off-street parking location and press a green button 10C on the device 10, see FIG. 2a. A green light, e.g., the green button 10C, starts to flicker and a message is displayed on the LCD panel 10A on the device 10. The message may state the following: the name of the city, the parking rates and times, and the device balance.

This action indicates that the city 50 is a subscriber to the service and that the device 10 has established a link with the server 20 of a service provider 15. In addition, this action indicates that the user has funds available to pay for the parking fee as set by that city. The user then simply sets the device 10 on the dash where it is visible to the parking enforcement officer. The server 20 may also communicate with a server (not shown) controlled by the city 50 informing the city that the user is currently parking at a particular location within the city and his/her device is valid.

Upon returning to the vehicle, the user may have two options. The user may press a red button 10D on the device 10 which communicates to the server 20 that the user is back in his vehicle and wants to leave from that location. If the user fails to press the red button 10D upon returning to his vehicle, the device 10 will deactivate itself 5 minutes after the vehicle changes its location. Either of the two above options deactivates the device 10. The server 20 then establishes the final parking charge and communicates the same to the device 10.

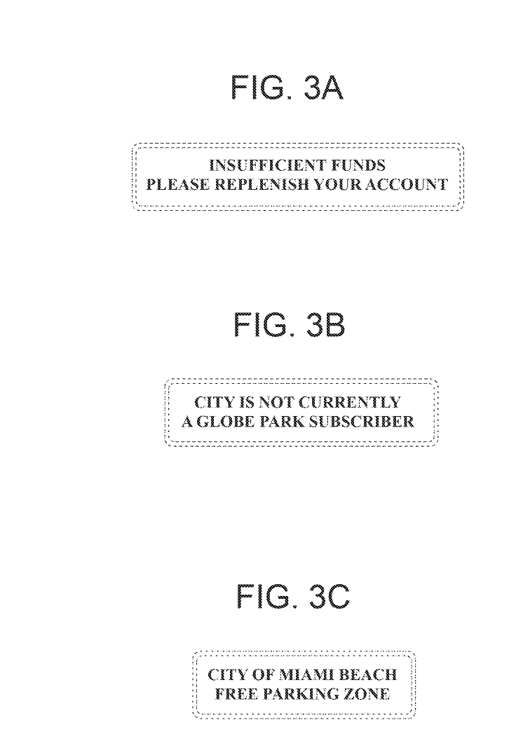

If the device 10 displays a solid red light, e.g., the red button 10D illuminates, then one of the exemplary messages shown in FIG. 3(a)-(c) may apply and be shown in the display 10A. As represented in FIG. 3(a), the user may have insufficient funds. In that case, the user can make a call to the service provider's toll-free number and add funds to the user account by using a credit card. As shown in FIG. 3(b), the city where the device 10 is located does not currently subscribe to the service. In that case, the user cannot use the device 10 and must find an alternate payment method to pay the parking charges to the city. A message as illustrated in FIG. 3(c) represents that the city does not charge any pre-mapped on-street and/or off-street parking rates for that particular location where the vehicle and the device 10 are currently present.

From the perspective of the city 50, there also are many benefits resulting from the present invention, including the following: no set up costs, real time revenue collection, flexibility to adjust rates based on peak hours or usage, and immediate reduction of collection costs.

Certain embodiments of the invention may also include a pre-paid plan. Under such a plan, a service provider 15 may offer on-street parking time in bulk at a discounted rate from the local governing authority.

Some embodiments of the invention may be set up for the city 50 by having the city 50 sign up as a subscriber with the service provider 15. The city 50 provides the service provider 15 with pre-mapped information regarding all on-street and off-street parking locations, its pre-mapped on-street and/or off-street parking rates and with its banking information where the parking charges are to be electronically transmitted. The city manager may send the same information in writing to the service provider's headquarters. The server 20 may then upload the information and recognize the city 50 as an active subscriber.

The server 20 may comprise a receiver 202 configured to receive a message from the device 10 at a parking location; a validator 204 configured to validate the device 10 as being genuine and located at a particular parking location based on the GPS location provided by the device 10 and the pre-mapped information regarding all on-street and off-street parking locations previously received from the city; a timer 206 configured to track a parking time; and a calculator 208 configured to calculate a parking revenue based upon a parking rate for the parking location and the parking time, see FIG. 1a. The server 20 further comprises an account manager 210 configured to define a user account associated with the device 10 and a revenue collector 212 configured to collect parking revenue from the user account. The server further comprises a collection manager 214 configured to verify collection of the parking revenue. The verification of the collection of the parking revenue by the server collection manager 214 may comprises receiving scanned bar code information taken from a bar code on the device 10 by an enforcement personnel, confirming the validation of the device 10 and confirming funds are in the user account such that parking revenue may be collected. The functions of validating the device, tracking parking time, calculating revenue, as well as the other server functions, may be accomplished, for example, through hardware, software or a combination of both without departing from the scope of the present invention.

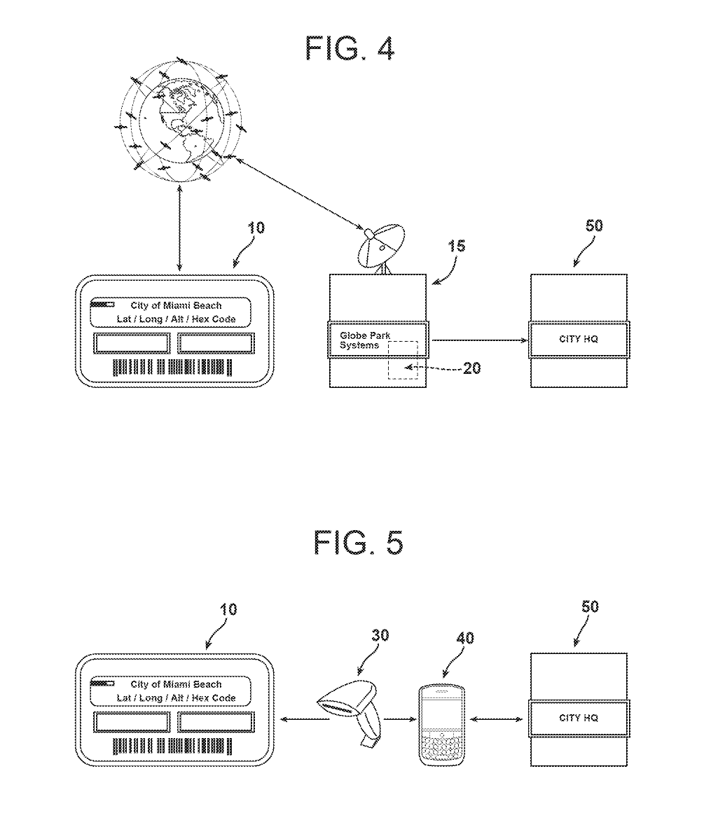

FIG. 4 shows an embodiment of the present invention. A user may park his or her car at any pre-mapped on-street and/or off-street parking location inside city limits. The user may activate the device 10 by pressing on the green button 10C once. This action may establish a link with the service provider 15 and a message received from the server 20 is flashed on the LCD screen 10A of the device 10. The message may include the location of the device 10 and the on-street parking rates in effect. This establishes the location of the vehicle inside the city limits and communicates the parking rates to the device 10. Once the device 10 is activated, it blinks green which clearly communicates to any enforcement officer that the parking charges for this vehicle are being collected electronically. When the user returns to the vehicle and drives away, the device 10 is automatically deactivated. Alternatively, as noted above, the user may press the red button 10D on the device 10, which deactivates the device 10.

Upon deactivation, a link is established to the server 20. The server 20 charges the user account as per the city's parking rate based on the time that the vehicle was at the location. Once the funds are taken from the user account by the server 20, the server 20 may transmit pre-negotiated proceeds to the city's bank account. The balance of the proceeds may be transferred to the service provider's account as a transaction fee and/or profit for each account/transaction. The city 50 can log on to the service provider's server 20 at any time to get a real time view of the number of vehicles parked within city limits using the server 20.

An enforcement officer patrolling a street may scan the bar code 10B on the device 10 in order to verify its authenticity as a device 10 provided by a service provider. Further, the bar code reader 30 can be linked to a device 40, such as a blackberry, which communicates with the city 50, which has already received a signal from the service provider 15 validating the device 10 as being genuine and currently within city limits. FIG. 5 depicts an embodiment wherein an enforcement personnel may verify the collection of parking revenue.

An embodiment may include a user interface, which may be a website. Such a web interface would be attractive, friendly, and easy to use. It would allow the user to input personal data and credit card information for billing. The web interface may provide a user with a parking activity report in real time. Such a report may show usage of the device 10 and a record of the transactional history of the funds for the account. The web interface may allow users to report a defective, damaged, lost, or stolen device. Also, the user may request that the service provider 15 cancel the device 10 and ship a replacement unit. Funds may be transferable from the original unit account to the replacement device account.

The city interface may also be a website. It may include a secure web interface with proprietary encoding that allows city officials to subscribe with a service provider. The city 50 may maintain and create city specific accounts where the city officials are provided with real time data relating to the usage. The city interface may have the capability to locate and identify all devices in operation within the city limits. The city interface may also provide a detailed report showing usage, monetary transactions per usage, and a full detailed history of each transaction. The service provider's server may transfer to the city's account every 24 hours, or as negotiated, an apportioned percentage of funds collected by devices in vehicles that were parked within the city limits, along with a detailed report. A website may include an enforcement interface that allows the enforcement personnel to verify, via the bar code reader 30 and his blackberry, if a device is genuine.

In a further embodiment of the present invention, a cell phone 101A such as a smart phone having GPS and wireless functions, one example of which is a 3G Apple iPhone, is used in place of the transponder 10. The cell phone 101A performs generally the same functions as the transponder 10, discussed above. It is intended that the term “device” as used herein encompasses a transponder, a cell phone or a like device.

Use of the cell phone 101A may occur as follows. A user may park his or her car at any pre-mapped on-street and/or off-street parking location inside city limits. The user may activate service via the cell phone 101A by enabling an application stored in the cell phone 101A which may virtualize the transponder functions, i.e., a graphic of the transponder 10 illustrated in FIG. 2A may appear on the cell phone 101A, allowing it to communicate with the service provider 15 so as indicate that the user's vehicle has arrived and is parked. The user may use the transponder graphic in the same manner that the transponder 10 is used as described above. Such an action indicating that a user's vehicle has arrived and is parked may establish a link with the service provider 15, resulting in the service provider 15 sending a URL message providing the location of the cell phone 101A and the pre-mapped on-street and/or off-street parking rates in effect. This establishes the location of the vehicle inside the city limits and communicates the parking rates to the device 101A. When the user returns to the vehicle and drives away, the device 101A may be manually deactivated by the application software embedded in the smart phone. Alternatively, the user may send a text, email or make a telephone call providing notice to the service provider 15 that parking has started and/or ended.

Instead of placing a bar code on the transponder 10 or the cell phone 101A, a bar code can be placed on the vehicle or a card to be placed on the vehicle dash so as to allow an enforcement personnel to verify the collection of parking revenue.

It is further contemplated that a commercial parking service may use this system in addition to a city or municipality. Further, parking may occur within a parking lot or on a street. The discussion above regarding use of the present system by a city also applies to a commercial parking service that may have one or more commercial parking lots that it owns or manages through one or more cities.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention, and has disclosed the ways the inventor now believes are the best ways to practice the invention. It is understood that the above description and drawings are merely illustrative of the present invention and that changes in components, structure and procedure are possible without departing from the scope of the present invention as defined in the following claims.

What is claimed is:

1. A method for collecting parking revenue comprising the steps of:
validating a device associated with a user account, wherein the device is validated as being genuine and located at a parking location;
transmitting a message to the device, wherein the message includes at least one of: the parking location of the device, a parking rate for the parking location, and a balance of the user account;
tracking a parking time that the device is located at the parking location; and
calculating parking revenue, wherein the parking revenue is based upon the parking rate and the parking time

2. The method of claim 1, further comprising:
sending an error message to the device, wherein the error message may include a message comprising one of: insufficient funds, non-subscribing location, free parking zone and free parking time.

3. The method of claim 1, further comprising:
adding user funds to a user account.

4. The method of claim 1, further comprising:
transferring funds to a bank account.

5. The method of claim 4, wherein the transferring of funds to a bank account comprises transmitting a first percentage of a transaction to a municipality bank account and transmitting a second percentage of the transaction to a service provider account, wherein the second percentage is a transaction fee.

6. The method of claim 1, further comprising:
verifying collection of parking revenue.

7. The method of claim 6, wherein the verification of the collection of the parking revenue comprises:
receiving scanned bar code information taken from a bar code on the device by an enforcement personnel;
confirming the validation of the device; and
transmitting collection information, wherein the collection information communicates to the enforcement personnel that the parking revenue is being collected.

8. The method of claim 1, further comprising collecting parking revenue from a user account.

9. The method of claim 1, further comprising:
providing to a user a parking activity report, wherein the parking activity report includes: a usage record of the device and a transactional history record of the user account.

10. A system for collecting parking revenue comprising:
a server comprising:
a receiver configured to receive a message from a device at a parking location;
a validator configured to validate the device as being genuine and located at a parking location;
a timer configured to track a parking time;
a calculator configured to calculate a parking revenue based upon a parking rate for the parking location and the parking time.

11. The system of claim 10, wherein said server further comprises an account manager configured to define a user account associated with the device and a revenue collector configured to collect parking revenue from the user account.

12. The system of claim 10, wherein said server further comprises a collection manager configured to verify collection of the parking revenue.

13. The system of claim 12, wherein the verification of the collection of the parking revenue by said server collection manager comprises:
receiving scanned bar code information taken from a bar code on the device by an enforcement personnel;
confirming the validation of the device; and
confirming funds are in a user account such that parking revenue may be collected.

14. The system of claim 10, wherein said validator validates the device as being located at a particular parking location based on a GPS location provided by the device and pre-mapped information regarding all on-street and off-street parking locations previously received from the city.

15. A self-locating device for transmitting parking related information comprising:
a first receiver configured to acquire a position of said device via GPS;
a transmitter configured to transmit the location of said device to a server;
a second receiver configured to receive information back from the server comprising current parking rates; and
a display for displaying the information.

16. The self-locating device as set out in claim 15, wherein said device comprises a transponder or a cell phone.

17. The self-locating device as set out in claim 15, further comprising a bar code so as to allow an enforcement personnel to verify the collection of parking revenue.

18. The self-locating device as set out in claim 15, further comprising a deactivation circuit to deactivate the device and said transmitter being further configured to generate a corresponding signal to a server indicating that parking has ended.
